(19) United States
(12) Patent Application Publication
(10) Pub. No.: US 2014/0118259 A1
(43) Pub. Date: May 1, 2014

(54) PORTABLE DEVICE AND METHOD FOR PROVIDING USER INTERFACE THEREOF

(71) Applicant: Pantech Co., Ltd., Seoul (KR)

(72) Inventors: Dong Hwa PAEK, Seoul (KR); Myo Hyeon GYEONG, Seoul (KR); Jang Bin YIM, Seoul (KR)

(73) Assignee: Pantech Co., Ltd., Seoul (KR)

(21) Appl. No.: 14/069,039

(22) Filed: Oct. 31, 2013

(30) Foreign Application Priority Data
Nov. 1, 2012 (KR) 10-2012-0123170

(51) Int. Cl. G06F 3/0346

(52) U.S. Cl. CPC G06F 3/0346
USPC 345/158

(57) ABSTRACT

A method for providing a user interface based on a light sensor includes recognizing a motion of an object with respect to a portable device based on a light signal received by at least one light sensor of the portable device and, according to the motion of the object, controlling an application of the portable device. A portable device to provide a user interface based on a light sensor includes at least one light sensor to recognize a motion of an object with respect to the portable device based on a light signal received by at least one light sensor and a control unit to control an application of the portable device according to the motion of the object.

### CROSS-REFERENCE TO RELATED APPLICATION

This application claims priority from and the benefit under 35 U.S.C. §119(a) of Korean Patent Application No. 10-2012-0123170, filed on Nov. 1, 2012, which is hereby incorporated by reference for all purposes as if fully set forth herein.

### BACKGROUND

1. Field

The present disclosure relates to a portable device and a method for providing a user interface thereof, and, more particularly, to a portable device and a method for providing a user interface, which ensures an efficient user interface utilizing motion recognition.

2. Discussion of the Background

The advent of the 3^{rd} generation of mobile communication made mobile phones as almost essential gadgets, and mobile phones have evolved from the 3^{rd} generation to the 4^{th} generation. In accordance with the development of information technology, the performance of a portable device has rapidly evolved. Unlike the mobile phones of older generations limited to simple voice or message communications based on circuit switched networks, portable devices of newer generations serve as multi-purpose gadgets or a handheld computers for providing various contents, such as moving pictures and games. Smartphones have provided such evolved features based on packet-based communication networks capable of faster data communications. Further, various portable devices have emerged with more diverse and user-friendly functions providing more convenient user interfaces. Among the various functions, a motion recognition function is one of the main themes in the developments of evolving user interfaces.

A motion recognition function may recognize a motion of a human body, e.g., a motion of a user's hand, by using a motion recognition method and performing a predefined function. A portable device recognizes a motion of a human body by using a sensor. According to such a motion recognition function, a user may input a control input to a terminal without directly pressing a key button provided at the terminal in order to perform a desired function.

Further, conventional portable devices do not provide various types of motion recognition functions. For example, when a conventional portable device receives a message, the portable device does not provide various control functions based on different motion recognitions capable of being recognized. Therefore, in order to check contents of the message, the user inputs a secondary input by touching the touch screen or pressing a key button.

### SUMMARY

The present disclosure relates to portable device and a method for providing a user interface using motion recognition sensors.

Additional features of the invention will be set forth in the description which follows, and in part will be apparent from the description, or may be learned by practice of the invention.

Exemplary embodiments of the present invention provide a method for providing a user interface based on a light sensor, the method including: recognizing a motion of an object with respect to a portable device based on a light signal received by at least one light sensor of the portable device; and, according to the motion of the object, controlling an application of the portable device.

Exemplary embodiments of the present invention provide a portable device to provide a user interface based on a light sensor, including: at least one light sensor to recognize a motion of an object with respect to the portable device based on a light signal received by at least one light sensor; and a control unit to control an application of the portable device according to the motion of the object.

Exemplary embodiments of the present invention provide a portable device to provide a user interface based on an infrared sensor, including: a plurality of infrared sensors to recognize a motion of an object with respect to the portable device based on a respective pattern of infrared signals received by the plurality of infrared sensors; and a control unit to control an application of the portable device according to the motion of the object.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a portable device according to an exemplary embodiment of the present invention.

FIG. 2A is a view showing a portable device according to an exemplary embodiment of the present invention.

FIG. 2B is a view showing a motion recognizing unit according to an exemplary embodiment of the present invention.

FIG. 3 is a flowchart illustrating a method for providing a user interface through motion recognition according to an exemplary embodiment of the present invention.

FIG. 4 shows an initial screen of a portable device according to an exemplary embodiment of the present invention.

FIG. 5A, FIG. 5B, and FIG. 5C are views showing a motion recognition function according to an exemplary embodiment of the present invention.

FIG. 6A and FIG. 6B are views showing a motion recognition function according to an embodiment of the present invention.

FIG. 7Aa and FIG. 7B are data quantity graphs of infrared rays received at a motion recognizing unit with respect to an upward motion according to an exemplary embodiment of the present invention.

FIG. 8A and FIG. 8B are data quantity graphs of infrared rays received at the motion recognizing unit with respect to a downward motion according to an exemplary embodiment of the present invention.

FIG. 9A and FIG. 9B are data quantity graphs of infrared rays received at the motion recognizing unit with respect to a leftward motion according to an exemplary embodiment of the present invention.

FIG. 10A and FIG. 10B are data quantity graphs of infrared rays received at the motion recognizing unit with respect to a rightward motion according to an exemplary embodiment of the present invention.

FIG. 11 is a data quantity graph of infrared rays received at the motion recognizing unit with respect to a stop motion according to an exemplary embodiment of the present invention.

FIG. 12 is a flowchart illustrating a motion recognition process of S105 depicted in FIG. 3 according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. In the drawings, the size and relative sizes of layers and regions may be exaggerated for clarity. Like reference numerals in the drawings denote like elements. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

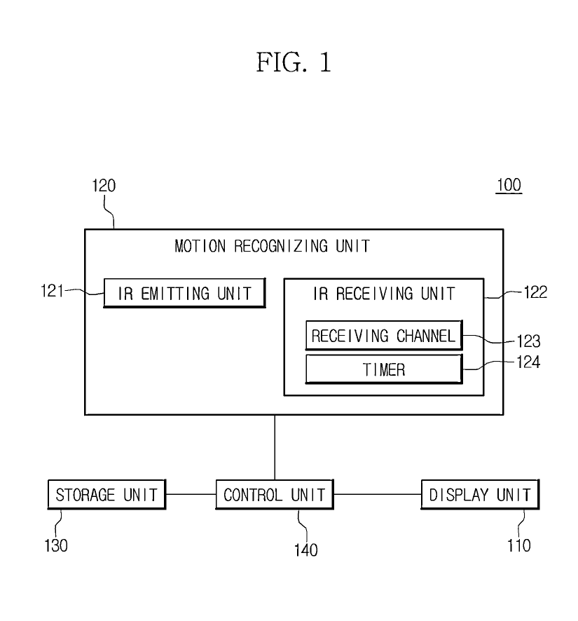

Referring to FIG. 1, a portable device 100 includes a display unit 110, a motion recognizing unit 120, a storage unit 130, and a control unit 140.

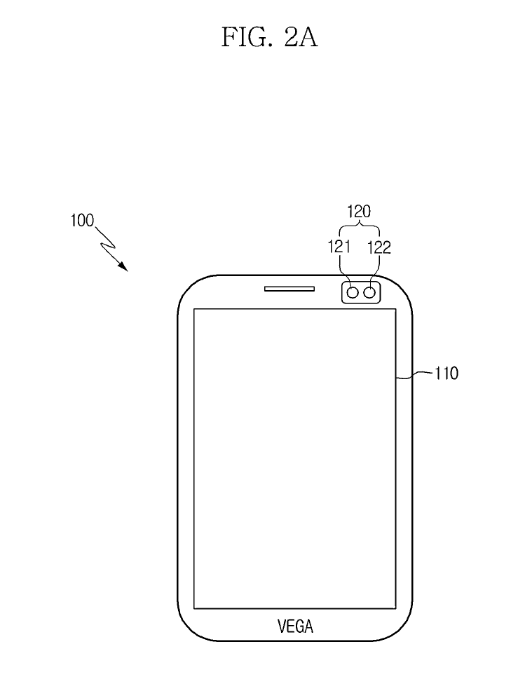

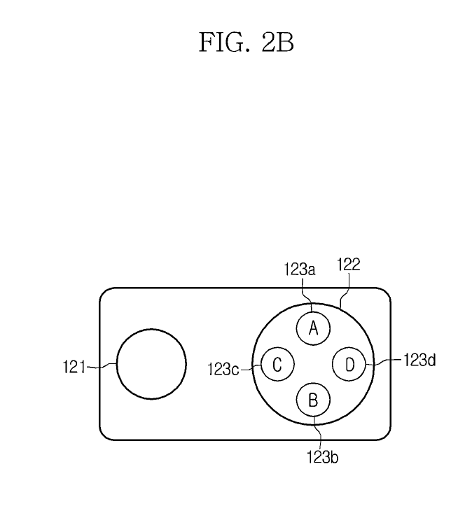

The display unit 110 displays contents according to an input of a user or a program, and the like. For example, the display unit 110 displays an image where a specific application is executed or a moving picture according to an input of a user. In addition, the display unit 110 may display an event occurrence message or an event indicator when a specific event occurs. For example, when a short message service (SMS) message, an email, or an image is received, the display unit 110 may display a message on an initial screen, an idle screen, a waiting screen, or a locked screen of the portable device 100 to inform that a new SMS message or an email is received by the portable device 100. As shown in FIG. 2A, the display unit 110 may be disposed at a front surface of the portable device 100 or formed as a part of the front surface of the portable device 100. Further, other types of applications for providing message communications via a packet switched or other networks may be controlled based on the methods and processes described herein. For example, events of mobile communication messengers, social network service programs, electronic mail, call reception, and the like may be applicable as well as the SMS message event.

The motion recognizing unit 120 recognizes a motion of an object. The motion recognizing unit 120 may recognize a motion of an object around the portable device 100 or located in proximity to the portable device using a motion sensor, e.g., an infrared sensor utilizing infrared radiations or infrared rays. The infrared radiations or the infrared rays may be referred to as an infrared signal. Referring to FIG. 2A, the motion recognizing unit 120 may be disposed at an edge area, e.g., a bezel area, of the front surface of the portable device 100 to emit and receive infrared rays or infrared radiations, thereby recognizing a motion of a human body of the user. More specifically, the motion recognizing unit 120 includes an infrared ray (IR) emitting unit 121 and an IR receiving unit 122. The IR ray emitting unit 121 and the IR receiving unit 122 may be arranged in parallel or adjacent to each other. The IR receiving unit 122 may include a plurality of infrared sensors.

The IR emitting unit 121 emits infrared rays periodically or in short cycles. Further, the IR emitting unit 121 may emit infrared rays in response to an occurrence of an event, such as a receipt of a message, an email, and the like.

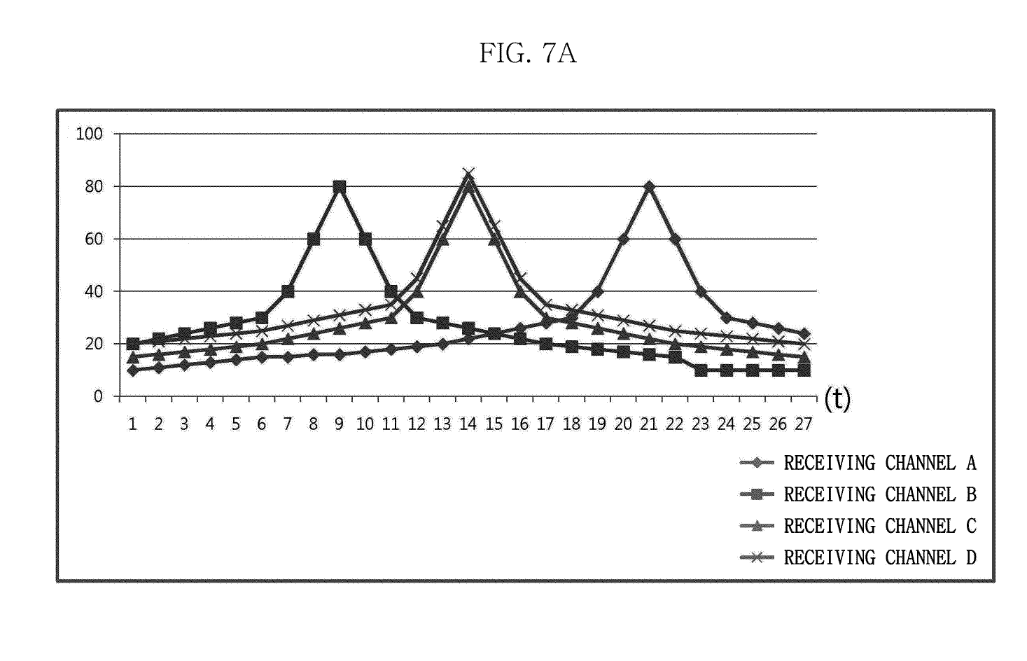

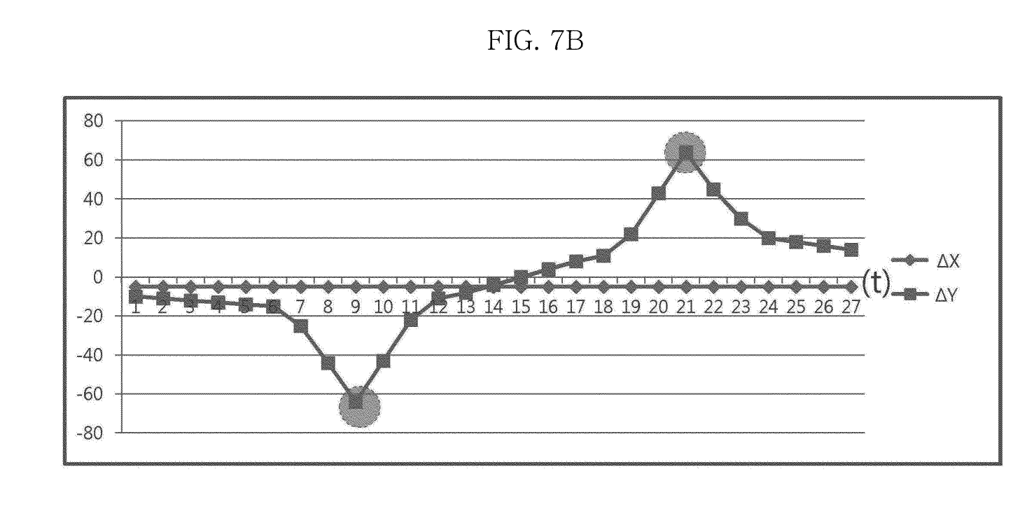

If the emitted infrared rays are reflected by the human body of the user, the IR receiving unit 122 may receive the reflected infrared rays. The IR receiving unit 122 includes a receiving channel for receiving infrared rays and a timer 124 for measuring time. The IR receiving unit 122 may sense the intensity of the reflected infrared rays in real time as shown in FIG. 7A through FIG. 11.

Referring to FIG. 2B, a plurality of receiving channels may be included, e.g., a receiving channel A 123a, a receiving channel B 123b, a receiving channel C 123c, and a receiving channel D 123d. For example, at least four receiving channels may be included. However, two or three channels may be configured in the portable device 100 in certain implementations. Each receiving channel may correspond to an infrared sensor or an infrared sensor group. The plurality of receiving channels may be disposed at upper, lower, right and left locations on the front surface of the portable device 100. For example, the receiving channel A 123a may be disposed at an ‘upper’ location, the receiving channel B 123b may be disposed at a ‘lower’ location, the receiving channel C 123c may be disposed at a ‘left’ location, and a receiving channel D 123d may be disposed at a ‘right’ location. The receiving channels detect data quantities of infrared rays (“the intensity of detected infrared rays for each receiving channel”) in real time. For example, infrared radiation sensors may measure the amplitude of received infrared radiation in real time. Since the receiving channels 123 are positioned at different locations, detection patterns detected by the receiving channels 123 are different according to the motion direction of a human body. For example, according to different motion direction, relative detection time of the reflected infrared rays may be different for the receiving channels 123. More specifically, the receiving channel A 123a may have relatively quicker detection of the radiated infrared rays in comparison with the receiving channel B 123b if the motion is a downward motion, which covers the receiving channel A 123a before covering the receiving channel B 123b. If a human body is in a stop state, data quantities detected by the receiving channels 123 may be identical to each other or may be substantially constant regardless of the detection time. The stop state may be a state in which an object, e.g., a human body, is partially or entirely covering the IR receiving unit 122 such that at least a portion of infrared rays radiated from the IR emitting unit 121 is received by the IR receiving unit 122. Based on the detected patterns of the plurality of IR receiving channels, a motion of the human body, e.g., the direction of the motion, the speed of the motion, and the like, may be detected by comparing data quantities detected by the receiving channels. Further, the receiving channels 123 may detect thermal energy radiated from an object capable of radiating thermal energy and may recognize the motion of the object.

The timer 124 measures time and determines whether the motion of the human body is made within a preset time. To ensure the control unit 140 to rapidly respond to the motion of the human body, the motion of the human body made within the preset time may be recognized and determined to control the portable device 100 based on the determined motion. The timer 124 may generate count signals in regular cycles, counts an occurrence frequency of the count signals and measures time by using the counted frequency.

Meanwhile, time may also be measured using a real time clock (RTC) function included in the portable device 100. In this case, the IR receiving unit 122 may not separately include the timer 124.

The storage unit 130 may store programs for processing or controlling of the control unit 140, or may temporarily store input/output data (for example, a phonebook, messages, still images, moving pictures or the like). The storage unit 130 may include at least one type of storage medium, for example, a flash memory type storage medium, a hard disk type storage medium, a multimedia card micro type storage medium, a card type memory (e.g., an SD or XD memory), RAM, ROM or the like.

The control unit 140 may generally control overall operations of the portable device 100. For example, the control unit 140 controls and processes voice calls, data communication, video call or the like. In addition, the control unit 140 may include a multimedia control module for playback multimedia data.

Further, the control unit 140 may control the display unit 110 and the motion recognizing unit 120 to provide the user with contents based on motion recognition after an event occurs. More specifically, if a registered event, such as receipt of an SMS message or email, occurs, the control unit 140 controls the display unit 110 to display an event occurrence message. Further, in response to the occurrence of the registered event, the control unit 140 controls the motion recognizing unit 120 to operate so that the motion recognizing unit 120 may emit and receive infrared rays. After that, if a specific motion is recognized, the control unit 140 controls the display unit 110 to display contents of the event. The IR emitting unit 121 and the IR receiving unit 122 may be separately controllable. For example, the IR emitting unit 121 may be enabled when a certain event occurs and be operable for a certain period after the enablement while the IR receiving unit 122 may be operable regardless of whether the occurrence of the event.

The specific motion may be a motion of a human body (for example, a hand or an arm) of the user, which moves toward a direction or stops for a predetermined time at the front surface of the portable device 100. The direction may be an upward direction, a downward direction, a right direction, a left direction, a diagonal direction or the like. Further, the control unit 140 may control the display unit 110 to display an event content confirmation mode of an application associated with the event or an event list.

Although not shown in the drawings, the portable device 100 may include a power supply to receive an external or internal power and supplying the power to operate each component under the control of the control unit 140.

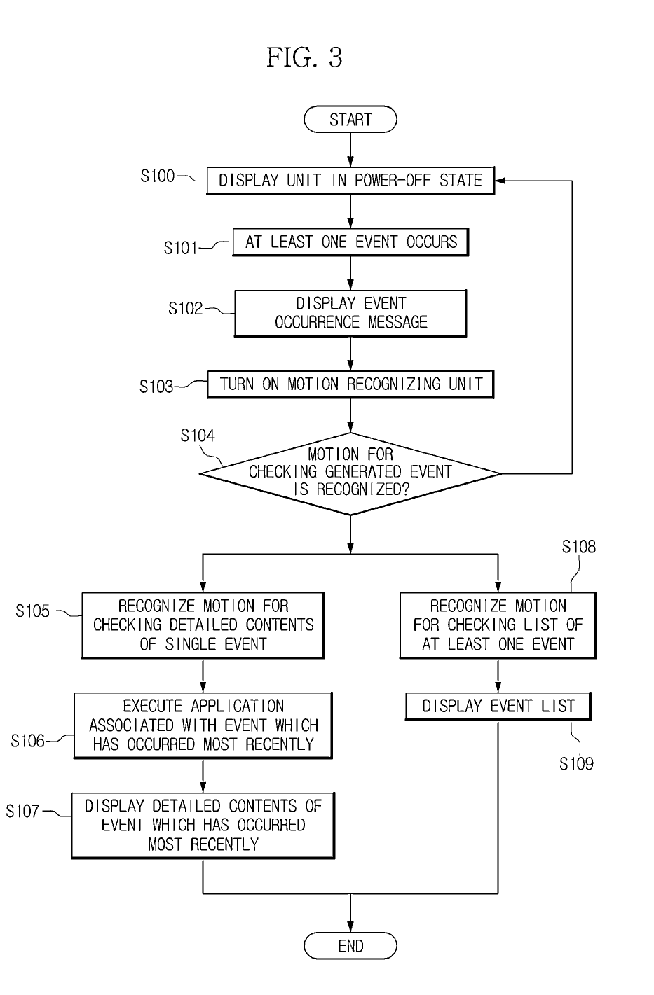

Hereinafter, a method for providing a user interface based on motion recognition will be described with reference to FIG. 3 to FIG. 6B. FIG. 3 will be described as if performed by the portable device 100 shown in FIG. 1, but is not limited as such.

The display unit 110 may be in a power-off state or an idle state (operation S100). A registered event may occur when the display unit 110 is in the power-off state, standby state, the idle state, or other state. For example, an event may occur when the display unit 110 is in a power-on state or a power-on state other than the idle state.

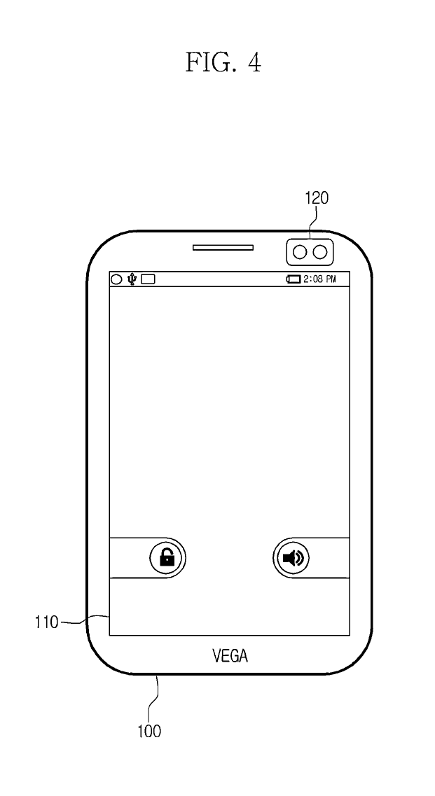

In operation S101, at least one event occurs. If at least one event occurs, the control unit 140 turns on the display unit 110, and the display unit 110 displays an initial screen. The initial screen (or an idle screen) may be a locked screen as shown in FIG. 4. In the initial screen, a user input to unlock the locked state of the portable device 100 may be received or a motion recognition input may be recognized. For example, if an SMS message is received in a state where the display unit 110 of the portable device 100 is turned off, the initial screen may be displayed in response to the receipt of the SMS message.

The control unit 140 controls the display unit 110 to display an event occurrence message or an event indicator on the initial screen (operation S102). The event occurrence message may display brief contents of the event or the number of events not checked by the user. For example, if a plurality of events occurs, the event occurrence message may display contents of only several events occurred recently, and the display of the contents may be performed within limited bytes. As shown in FIG. 4, the event occurrence message may display that one SMS message has not been checked by the user. The occurrence of an event indicating a receipt of an SMS message may be displayed with an icon but is not limited thereto.

The control unit 140 operates the motion recognizing unit 120 (operation S103). The motion recognizing unit 120, when operable, emits infrared rays and receives reflected infrared rays to recognize a motion of an object, e.g., the human body of the user.

The control unit 140 determines whether a motion for checking the occurrence of an event is recognized (operation S104). If a motion for checking the occurrence of an event is not recognized, the control unit 140 controls the display unit 110 to be turned off.

Motions for checking the occurrence of an event may be classified into two kinds of motions, namely a motion for checking contents of a single event and a motion for checking a list of at least one event.

The motion for checking contents of a single event includes a reciprocating motion of a human body on the portable device 100 or a motion of stopping the human body on the portable device 100 for a predetermined time (operation S105).

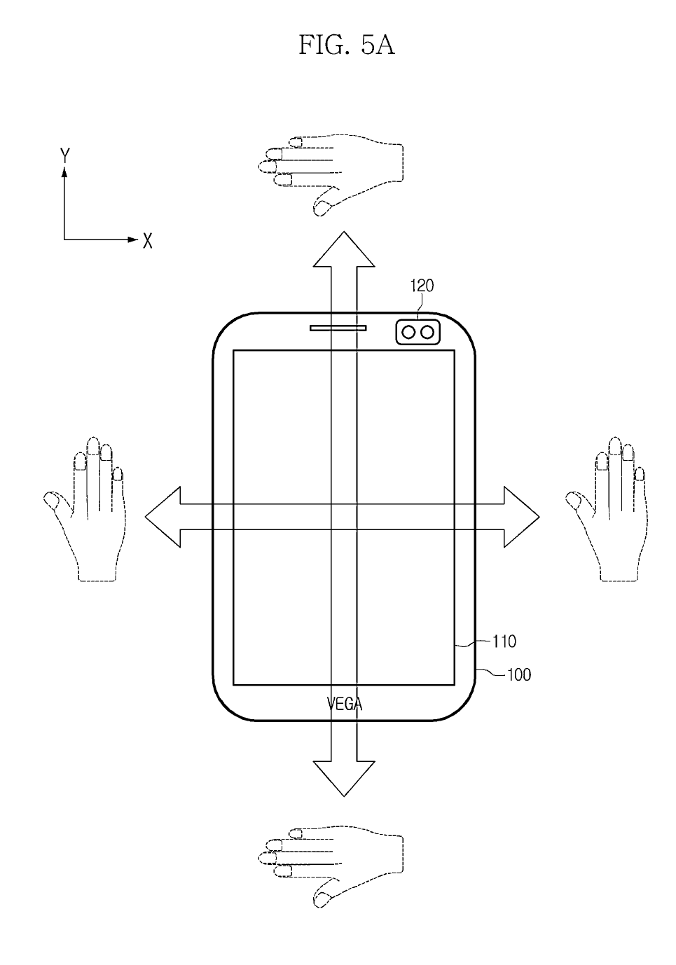

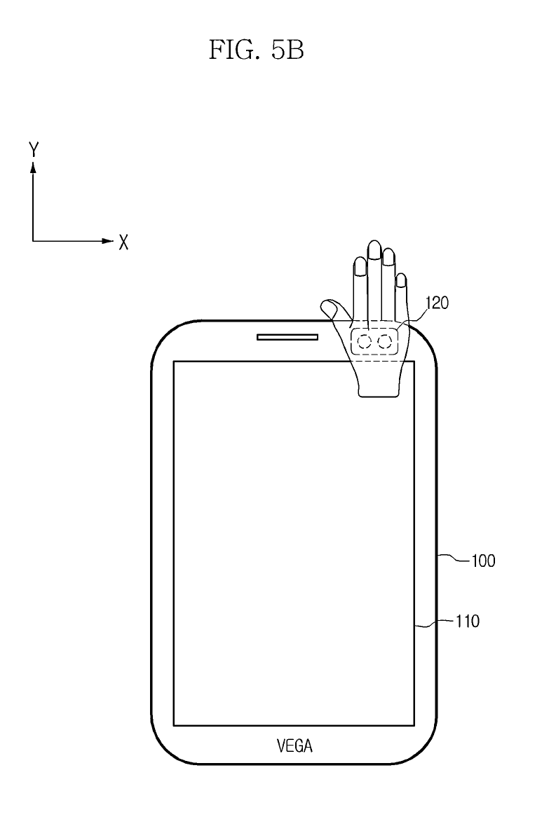

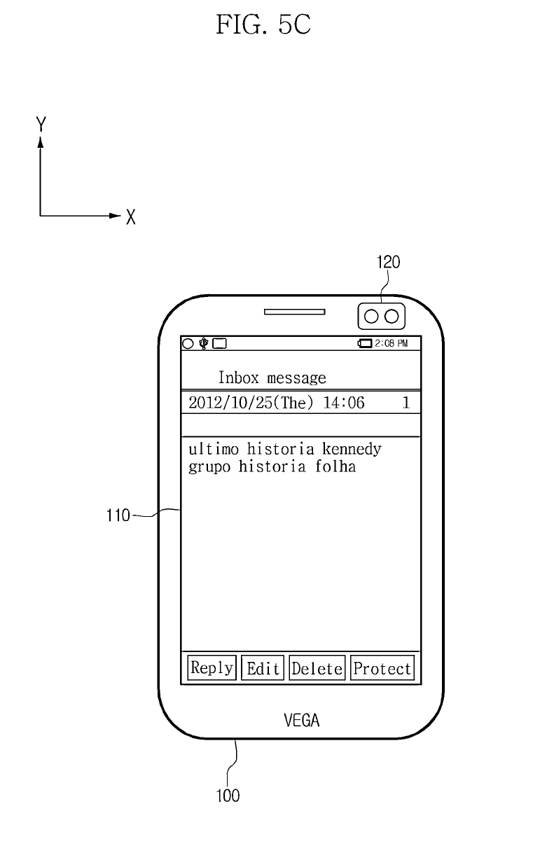

Referring to FIG. 5A, if the user moves his or her hand back and forth in a vertical direction (in a y-axis direction) or in a lateral direction (in an x-axis direction) on the portable device 100, this motion may be recognized as a motion for checking contents of an event, for example. Different motions, such as a hand movement in a diagonal direction may also be included as the motion for checking contents of an event.

In addition, referring to FIG. 5B, if the user stops the hand for a predetermined time at a certain location, which covers the motion recognizing unit 120, this motion may be recognized as a motion for checking contents of an event. Since the motion is recognized based on infrared rays reflected by the hand, the hand of the user is located within a certain range capable of covering the motion recognizing unit 120.

Further, the motion for checking a list of at least one event may include a motion of moving the human body in one direction on the portable device 100 (operation S108).

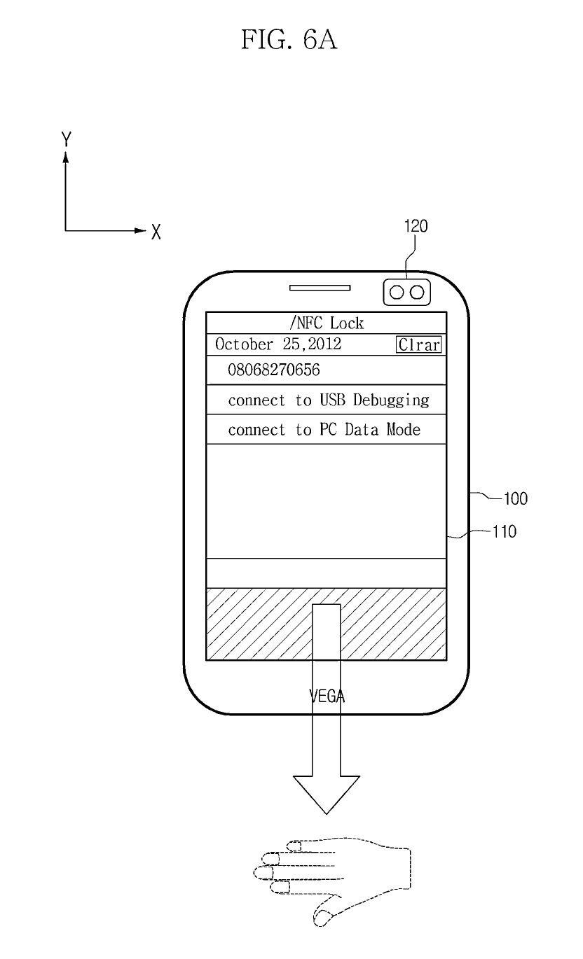

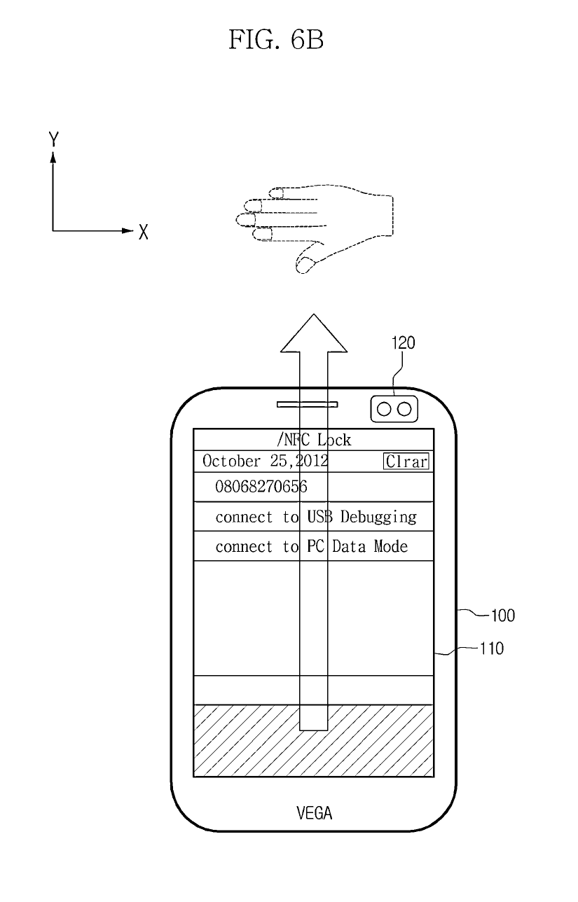

Referring to FIG. 6A, if the user moves the hand in a lower direction (in a downward direction of the y axis), this motion may be recognized as a motion for checking an event list. However, aspects are not limited thereto. For example, a motion toward a certain direction on a plane parallel to the x axis and the y axis may be selected as the motion for checking an event list.

An object, e.g., the hand, may move in front of the motion recognizing unit 120 while the object is spaced apart from the motion recognizing unit 120 in a z-axis direction (i.e., perpendicular to the x-axis and y-axis directions or perpendicular to the surface of the display in which the motion recognizing unit 120 is mounted). If the object is spaced too much from the motion recognizing unit 120 in the z-axis direction or located too closely to the motion recognizing unit 120 with respect to the z-axis, the motion recognition may be less accurate. For example, reflected lights may be input to the IR receiving unit 122 excessively, and noise may increase such that motion recognition may not be performed properly if the distance between the object and the motion recognizing unit 120 in the z-axis is not properly determined.

If the motion recognizing unit 120 recognizes a motion of the human body, for example, if the human body moves back and forth along an axis or a direction or stops on the portable device 100 as determined in the operation S105, the control unit 140 may execute an application associated with an event, which has occurred most recently among the at least one event (operation S106). For example, if the event which has occurred most recently is an SMS message, the control unit 140 executes an SMS management application. Further, the control unit 140 may execute an application associated with an event corresponding to the recognized motion, e.g., an event corresponding to a direction of the recognized motion.

The control unit 140 may control the display unit 110 to display contents of an event, which occurred most recently (operation S107). More specifically, the control unit 140 controls the display unit 110 to display an event content confirmation mode of the application, and specific contents of the event may be checked through the event content confirmation mode.

For example, specific contents of an SMS message received most recently may be displayed by executing an SMS management application and displaying an SMS confirmation s mode of the application, as shown in FIG. 5C.

Further, if the motion recognizing unit 120 detects another motion of the user after displaying the recent event content confirmation mode, the display unit 110 may display an event, which occurred subsequently. The other motion of the user may be a motion of the user's hand in one direction or a motion of covering the motion recognizing unit 120 on the portable device 100. Further, in order to display the event occurred subsequently, specific contents of the event may be displayed by executing an application. The process may be similar to operations S106 and S107.

If the motion recognizing unit 120 recognizes a motion of the human body for checking a list of events, e.g., a motion toward a certain direction (operation S108), the control unit 140 may control the display unit 110 to display a list of at least one occurred event (operation S109).

Referring to FIG. 6A, the event list may be displayed and scrolled according to a moving direction of the human body. For example, if a downward motion is recognized, the event list may be displayed at the display unit 110 and scrolled downward or upward. More specifically, according to the downward motion, the event list may be scrolled such that event items located at the upper portions of the event list may be displayed and event items in the event list may be scrolled toward the bottom of the screen. The event list may be a list showing brief information of each unchecked event. For example, for an SMS message reception event, content of the SMS message may be partially displayed. For an event about a connection of a terminal, information about a connection state may be displayed.

Further, as shown in FIG. 6B, the control unit 140 may remove the event list by recognizing another motion after the event list is displayed. In this case, the event list may also be scrolled and removed from the display by scrolling toward a direction corresponding to the moving direction of the human body.

As described above, specific contents of an event may be provided through single motion recognition, or contents desired by the user may be obtained without any secondary input other than motion recognition by providing the event list. Based on simple motion gestures, contents may be obtained more rapidly in comparison with a configuration in which contents are obtained by pressing a button of the portable device 100.

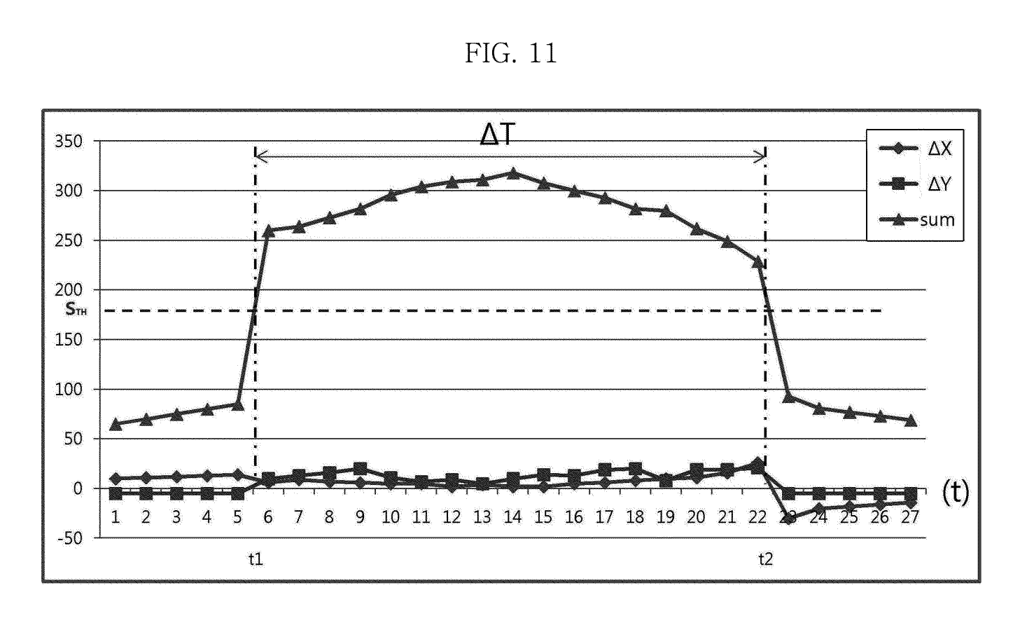

Hereinafter, a motion recognition process according to an embodiment of the present disclosure will be described with reference to FIG. 7A to FIG. 12. A plurality of receiving channels (e.g. “a plurality of infrared sensors”) may calculate an intensity of a received infrared signal. The intensity may be calculated as a digitized value and stored as a data quantity. Each receiving channel may recognize a pattern of the intensity of received infrared signal in real time, and a motion of an object may be recognized based on a respective pattern of infrared signals received by the plurality of infrared sensors. In the graphs shown in FIG. 7Aa to FIG. 11, the x-axis represents time t and the y-axis represents data quantity (digital value) of infrared rays. The data quantity of infrared ray may be proportional to a data quantity reflected by a human body and received by each receiving channel. In addition, Δx refers to “a data quantity of the receiving channel C 123c—a data quantity of the receiving channel D 123d” (a difference between the data quantity of the receiving channel D 123d and the data quantity of the receiving channel C 123c), and Δy refers to “a data quantity of the receiving channel A 123a—a data quantity of the receiving channel B 123b” (a difference between the data quantity of the receiving channel B 123b and the data quantity of the receiving channel A 123a).

Data quantities detected by each of the receiving channels of the motion recognizing unit 120 when a human body of the user moves in an upward direction on the portable device 100 will be described with reference to FIG. 7A and FIG. 7B.

Referring to FIG. 7Aa, a curve of data quantities of each receiving channel according to time may have a convex shape, quasiconvex shape, or the like with a peak value at a specific time. Although described with respect to a peak data value, aspects need not be limited thereto such that, for example, the data value may only exceed a threshold value and may not be a peak value. As the human body is positioned in a location to reflect the most infrared rays into a receiving channel, more reflected infrared rays may be received by the receiving channel and more data quantity may be detected by the receiving channel. In this regard, since the human body moves, the receiving channel and the human body are disposed most closely at a specific time. As shown in FIG. 7A, the data quantity received by each receiving channel may have a peak value of about 80. With respect to the time axis (x-axis), the receiving channel B 123b detects a peak data quantity for the first time. Then, the receiving channels C 123c and D 123d detect peak data quantities after the occurrence of the peak value in the receiving channel B 123b, and the data quantities detected by the receiving channels C 123c and D 123d and peak detection times of the receiving channels C 123c and D 123d are similar to each other. After the peak detections by the receiving channels C and D, the receiving channel A 123a detects a peak value of the reflected infrared rays. The receiving channels C 123c and D 123d detect data quantities substantially identically because, when the human body of the user moves along the upward direction, the human body passes by the receiving channels C and D substantially simultaneously, as shown in FIG. 2B. As shown in FIG. 7B, Δx always has a constant value, but Δy has a negative value at first and then has a positive data value later.

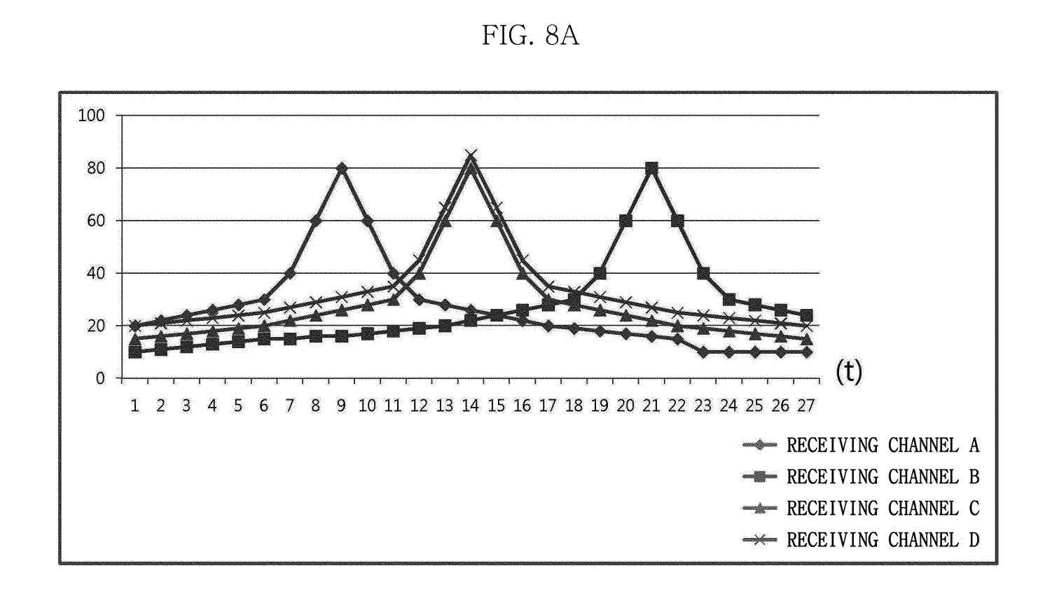

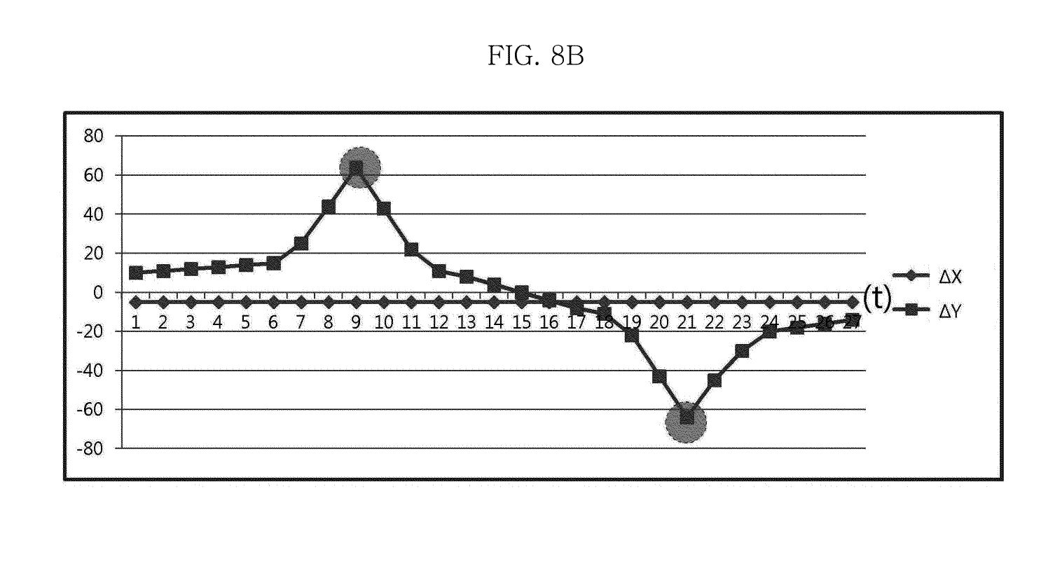

A data quantity detected by the receiving channels of the motion recognizing unit 120 when a human body of the user moves along the downward direction on the portable device 100 will be described with reference to FIG. 8A and 8B.

As shown in FIG. 8A, the receiving channel A 123a detects a peak data quantity before the detection of the peak data quantities by the other receiving channels. The receiving channels C 123c and D 123d detect peak data quantities after the detection of the peak data quantity by the receiving channel A 123a, and the receiving channel B 123b detects a peak data quantity after the detections of the peak data quantities by the receiving channels C 123c and D 123d. The data quantities detected by the receiving channels C 123c and D 123d may be substantially identical to each other as described above. As shown in FIG. 8B, Δx has a constant value, but Δy has a positive data value in the beginning and then has a negative data value later.

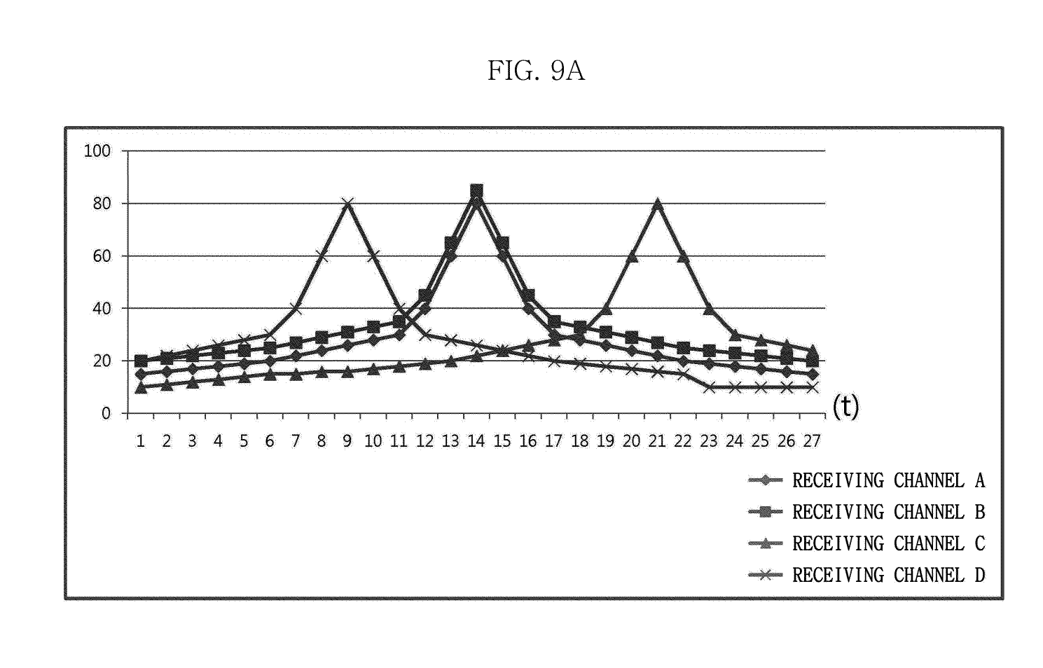

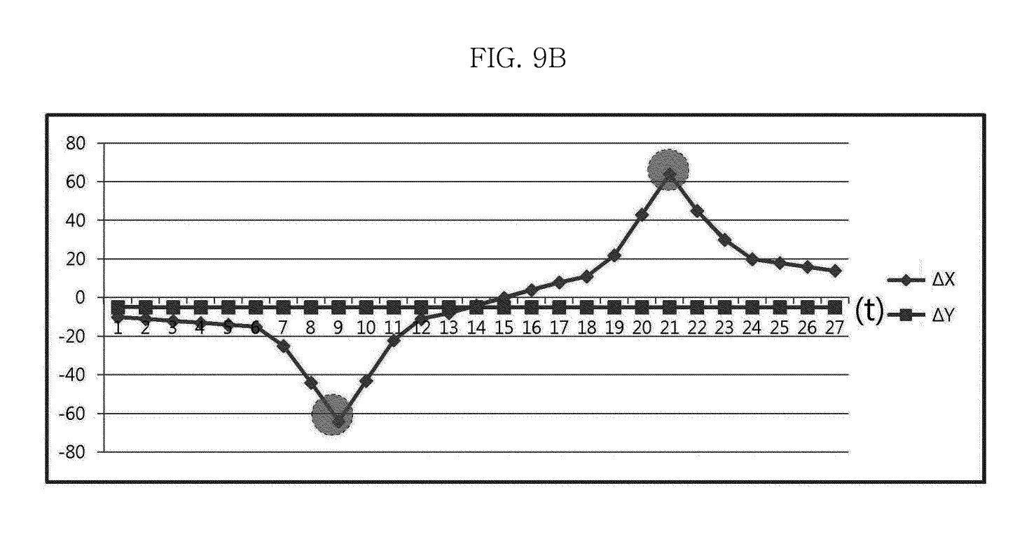

Data quantities detected by the receiving channels of the motion recognizing unit 120 when a human body of the user moves toward the leftward direction on the portable device 100 will be described with reference to FIG. 9A and FIG. 9B.

As shown in FIG. 9A, the receiving channel D 123d detects a peak data quantity before the detection of the peak data quantities by the other receiving channels. The receiving channels A 123a and B 123b detect peak data quantities after the detection of the peak data quantity by the receiving channel D 123d, and the receiving channel C 123c detects a peak data quantity after the detections of the peak data quantities by the receiving channels A 123a and B 123b. The data quantities detected by the receiving channels A 123a and B 123b may be substantially identical to each other as described above. As shown in FIG. 9B, Δy has a constant value, but Δx has a negative data value in the beginning and then has a positive data value later.

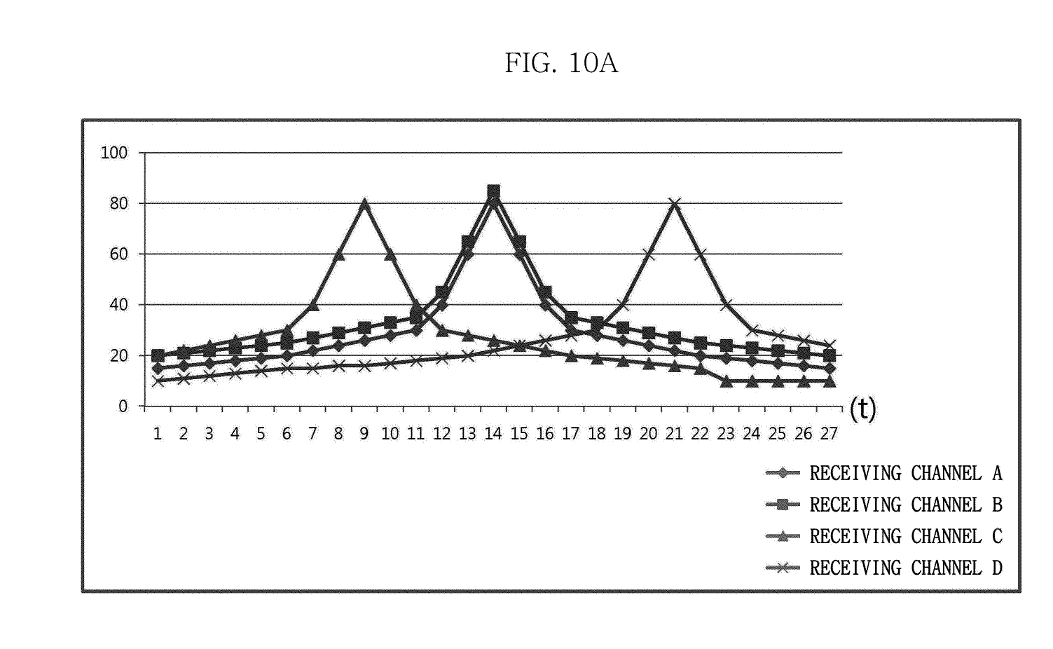

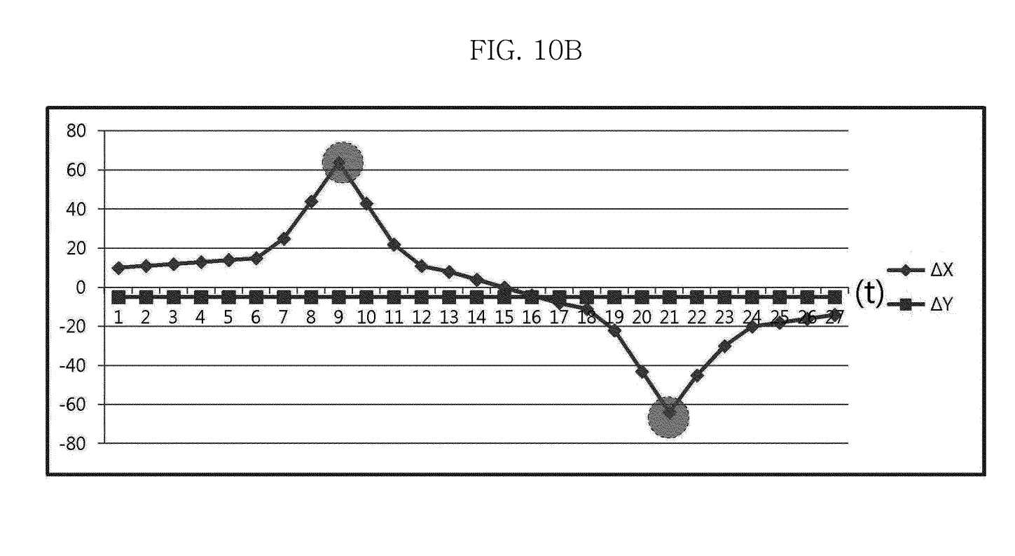

Data quantities detected by the receiving channels of the motion recognizing unit 120 when a human body of the user moves toward the rightward direction on the portable device 100 will be described with reference to FIG. 10A and FIG. 10B.

As shown in FIG. 10A, the receiving channel C 123c detects a peak data quantity before the detection of the peak data quantities by the other receiving channels. The receiving channels A 123a and B 123b detect peak data quantities after the detection of the peak data quantity by the receiving channel C 123c, and the receiving channel D 123d detects a peak data quantity after the detections of the peak data quantities by the receiving channels A 123a and B 123b. The data quantities detected by the receiving channels A 123a and B 123b may be substantially identical to each other as described above. As shown in FIG. 10B, Δy has a constant value, but Δx has a positive data value in the beginning and then has a negative data value later. The graph shown in FIG. 10A is substantially identical to the graph shown in FIG. 9A except for the graph shapes of the receiving channels C 123c and D 123d. More specifically, in FIG. 10A, the receiving channel C 123c detects a peak data quantity before the detections of the peak data quantities by the other receiving channels, and the receiving channel D 123d detects a peak data quantity after the detections of the peak data quantities by the other receiving channels. As a result, Δy has a constant value, but Δx has a positive data value in the beginning and then has a negative data value later.

As described above, with respect to a motion of a human body in one direction, data quantities detected by the receiving channels arranged on one axis (for example, the receiving channels A 123a and B 123b) are greatly different from each other. Here, the direction in which the receiving channels (for example, the receiving channels A and B) having varying data quantities (the vertical direction) is identical to the moving direction of the human body (the vertical direction). Therefore, a motion of a human body is detected using the data patterns.

Meanwhile, a motion of stopping for a predetermined time on the portable device 100 is detected using data different from the graphs above, and will be described with reference to FIG. 11.

For example, if the human body stays on the motion recognizing unit 120 of the portable device 100 by maintaining a certain distance from the motion recognizing unit 120 (“stop motion”), data quantities of infrared rays detected by all receiving channels may be substantially identical to each other. Therefore, it may be difficult to detect the stop motion by comparing data quantities detected by the receiving channels. Thus, the stop motion may be detected by using the sum of data quantities detected by all receiving channels.

In FIG. 11, the sum refers to a sum of data quantities of the receiving channels A 123a, B 123b, C 123c, and D 123d″. The stop motion for displaying contents of an event may be is recognized by determining whether the sum of data quantities is in excess of a threshold value S_{TH}. Further, if a duration in which the sum (ΔT=t2−t1) of data quantities exceeds the threshold value is in excess of a preset value (preset amount of time), the motion may be recognized as a stop motion for displaying contents of the event.

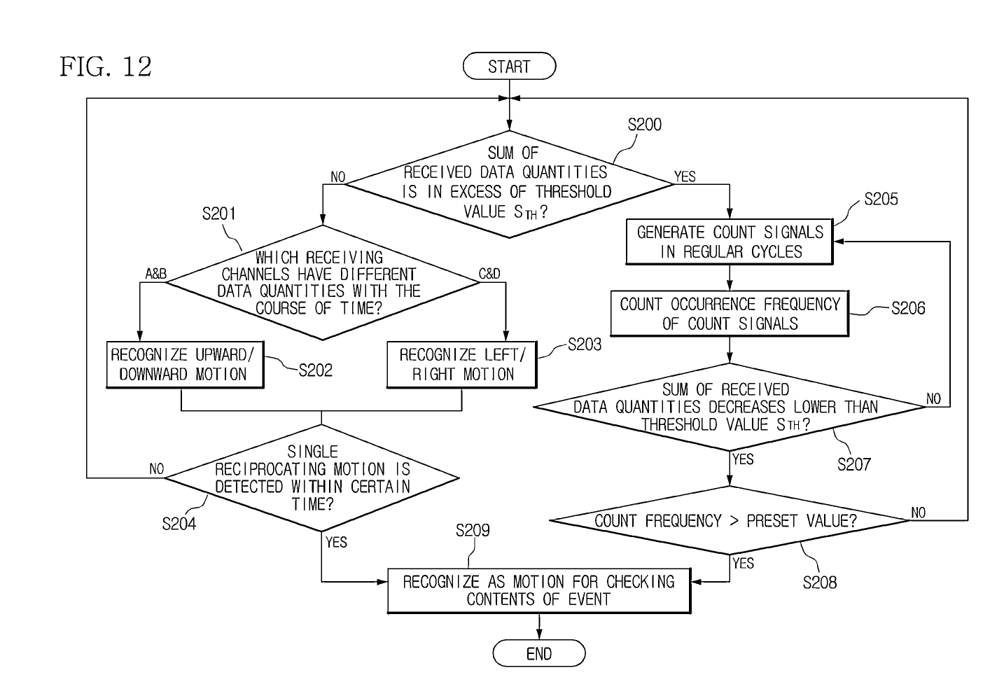

The motion recognition will be described in more detail with reference to FIG. 12.

If the receiving channels of the motion recognizing unit 120 detect data quantities of received infrared rays, it may be determined whether the sum of received data quantities is in excess of the threshold value S_{TH} (operation S200).

If the sum is not in excess of the threshold value S_{TH}, it may be determined whether one or more receiving channels have different data quantities of received infrared rays with the course of time (operation S201).

If the receiving channel A 123a and the receiving channel B 123b of the receiving channels are determined as having different data quantities, the motion is recognized as an upward or downward motion (operation S202). By determining the times for each receiving channel when a peak data value occurs, it may be possible to determine a direction from a mounted location of the receiving channel having a peak data value occurred earlier than the other receiving channels to a mounted location of the receiving channel having a peak data value occurred later than the other receiving channels as a moving direction of the human body. For example, for the upward motion, Δy changes from a negative value to a positive value with the course of time as shown in FIG. 7B, and in the downward movement, Δy changes from a positive value to a negative value with the course of time as shown in FIG. 8B.

If the receiving channel C 123c and the receiving channel D 123d of the receiving channels 123 are determined as having different data quantities, the motion may be recognized as a leftward or rightward motion (operation S203). The moving direction of the motion may be determined according to the methods described above, and as shown in FIG. 9B, if Δx changes from a negative value to a positive value with the course of time, the motion may be recognized as a leftward motion. As shown in FIG. 10B, if Δx changes from a positive value to a negative value with the course of time, the motion may be recognized as a rightward motion.

Further, it may be determined whether a single reciprocating motion is detected with respect to the single axis direction (operation S204). For example, it is determined whether a motion of the hand moving along the upward direction and then moving along the downward direction is detected.

If the condition of a single reciprocating motion is not satisfied, a motion for checking contents of the event may not be recognized. However, if the condition is satisfied, the motion may be recognized as a motion for checking contents of the event (operation S209).

If the sum of data quantities is larger than or equal to the threshold value S_{TH}, the timer 124 generates count signals in regular cycles (operation S205). If the count signal is generated at least once, a moving direction of the human body of the user toward the portable device is not recognized, and a moving direction of the human body of the user away from the portable device is also not recognized, thereby preventing the motion moving in one direction from being confused.

Then, the timer 124 counts a frequency of count signals (operation S206).

While operating the timer 124, it may be determined whether the sum of received data quantities decreases lower than the threshold value S_{TH} (operation S207). If the sum of data quantities does not decrease lower than the threshold value S_{TH}, the timer 124 keeps generating count signals.

However, if the sum of data quantities decreases lower than the threshold value S_{TH}, the timer 124 stops generating the count signal, and determines the number of count signals generated from a point or time when the sum of data quantity exceeds the threshold value S_{TH} to a point or time when the sum of data quantity decreases lower than the threshold value S_{TH}. Then, it may be determined whether the number of count signals is larger than or equal to a preset value (operation S208).

If the number of count signals is smaller than the preset value, a motion for checking contents of the event is not checked, but if the number of count signals is larger than or equal to the preset value, the motion is recognized as a motion for checking contents of the event (operation S209).

For example, when a count signal generation cycle is 500 ms and the preset value is four, if five count signals, which is larger than the preset value, are generated, the motion is recognized as a motion for checking contents of the event. More specifically, a stop motion recognition time for checking contents of an event is set longer than or equal to 2 seconds (500 ms multiplied by 4 seconds), and since the measurement time of the timer 124 is 2.5 seconds, the motion is recognized as a stop motion for checking contents of an event.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for providing a user interface based on a light sensor, the method comprising:
recognizing a motion of an object with respect to a portable device based on a light signal received by at least one light sensor of the portable device; and
according to the motion of the object, controlling an application of the portable device.

2. The method of claim 1, further comprising generating a light signal from the portable device if an event occurs at the portable device, the event being registered to be controlled according to the at least one light sensor.

3. The method of claim 2, wherein the generated light signal is reflected by the object, and the light signal received by the at least one light sensor is the reflected signal of the generated light signal.

4. The method of claim 1, wherein the at least one light sensor comprises:
a first light sensor spaced apart from a second light sensor along a first axis; and
a third light sensor spaced apart from the second light sensor along a second axis,
wherein the first axis and the second axis are perpendicular to each other.

5. The method of claim 1, wherein the at least one light sensor comprises:
a first light sensor spaced apart from a second light sensor along a first axis; and
a third light sensor spaced apart from a fourth light sensor along a second axis,
wherein the first axis and the second axis are perpendicular to each other.

6. The method of claim 1, further comprising:
calculating a time when an intensity of the received light signal is a peak value for each light sensor; and
recognizing a direction of the motion based on the calculated times of the at least one light sensor.

7. The method of claim 1, further comprising:
calculating a difference between an intensity of the light signal received by a first light sensor and an intensity of the light signal received by a second light sensor; and
recognizing a direction of the motion based on the difference.

8. The method of claim 1, further comprising:
calculating an aggregated intensity of the light signal received by the at least one light sensor; and
recognizing a stop motion of the object based on a change of the aggregated intensity.

9. The method of claim 8, further comprising:
calculating a duration in which the aggregated intensity is larger than or equal to a threshold value; and
recognizing the stop motion if the duration is longer than or equal to a preset duration value.

10. The method of claim 1, further comprising:
recognizing an occurrence of an event at the portable device;
operating the at least one light sensor in response to the occurrence of the event;
displaying an event list in response to a determination that the motion is of a first type, the event list comprising at least one event item; and
displaying content of the event in response to a determination that the motion is of a second type.

11. The method of claim 1, wherein the at least one light sensor is an infrared sensor and the light signal is an infrared signal.

12. A portable device to provide a user interface based on a light sensor, comprising:
at least one light sensor to recognize a motion of an object with respect to the portable device based on a light signal received by the at least one light sensor; and
a control unit to control an application of the portable device according to the motion of the object.

13. The portable device of claim 12, further comprising a light ray emitting unit to generate a light signal from the portable device if an event occurs at the portable device, the event being registered to be controlled according to the at least one light sensor.

14. The portable device of claim 13, wherein the generated light signal is reflected by the object, and the light signal received by the at least one light sensor is the reflected signal of the generated light signal.

15. The portable device of claim 12, wherein the at least one light sensor comprises:
a first light sensor spaced apart from a second light sensor along a first axis; and
a third light sensor spaced apart from the second light sensor along a second axis,
wherein the first axis and the second axis are perpendicular to each other.

16. The portable device of claim 12, wherein the at least one light sensor comprises:
a first light sensor spaced apart from a second light sensor along a first axis; and
a third light sensor spaced apart from a fourth light sensor along a second axis,
wherein the first axis and the second axis are perpendicular to each other.

17. The portable device of claim 12, wherein the control unit calculates a time when an intensity of the received light signal is a peak value for each light sensor, and to recognize a direction of the motion based on the calculated times of the at least one light sensor.

18. The portable device of claim 12, wherein the control unit calculates a difference between an intensity of the light signal received by a first light sensor and an intensity of the light signal received by a second light sensor, and to recognize a direction of the motion based on the difference.

19. The portable device of claim 12, wherein the control unit calculates an aggregated intensity of the at least one light sensor, and to recognize a stop motion of the object based on a change of the aggregated intensity of the at least one light sensor.

20. The portable device of claim 19, wherein the control unit further calculates a duration in which the aggregated intensity is larger than or equal to a threshold value, and recognizes the stop motion if the duration is longer than or equal to a preset duration value.

21. The portable device of claim 12, wherein the control unit recognizes an occurrence of an event at the portable device and operates the at least one light sensor in response to the occurrence of the event.

22. The portable device of claim 21, further comprising:
a display unit to display an event list in response to a determination that the motion is of a first type, the event list comprising at least one event item, and to display content of the event in response to a determination that the motion is of a second type.

23. The portable device of claim 12, wherein the at least one light sensor is an infrared sensor and the light signal is an infrared signal.
